(19) United States
(12) Patent Application Publication
(10) Pub. No.: US 2025/0199920 A1
(43) Pub. Date: Jun. 19, 2025

(54) Partition-based Escrow in a Distributed Computing System

(71) Applicant: Ab Initio Technology LLC, Lexington, MA (US)

(72) Inventor: Zori Babroudi, Concord, MA (US)

(21) Appl. No.: 18/980,527

(22) Filed: Dec. 13, 2024

Related U.S. Application Data
(60) Provisional application No. 63/609,517, filed on Dec. 13, 2023.

(51) Int. Cl. G06F 11/16; G06F 16/23

(52) U.S. Cl. CPC G06F 11/1658; G06F 16/2365; G06F 2201/88

(57) ABSTRACT

A method for fault-tolerant processing of a number of data elements using a distributed computing cluster. The distributed computing cluster includes a number of data processors associated with a corresponding number of data stores. The method includes storing the data elements in the distributed computing cluster, wherein the data elements are distributed across the data stores according to a number of partitions of data elements, processing data elements of a first set of partitions stored at a first data store using a first data processor to generate first result data for the data elements of the first set of partitions, sending the first result data from the distributed computing cluster to a consumer of the first result data outside the distributed computing cluster, and storing the first result data in a first buffer located in the distributed computing cluster and associated with the first data processor until the consumer has persistently stored the first result data outside the distributed computing cluster.

### CROSS-REFERENCES TO RELATED APPLICATIONS

This application claims the benefit of U.S. Provisional Application No. 63/609,517 filed Dec. 13, 2023, the entire contents of which are incorporated herein by reference.

### BACKGROUND OF THE INVENTION

This invention relates to fault tolerance in distributed computing systems.

Distributed computing systems may include computing clusters implemented as networks of interconnected computing devices (sometimes referred to as nodes) that work together to solve complex tasks by breaking them down into smaller sub-tasks and processing them concurrently. By harnessing the collective power of multiple computers, distributed computing clusters achieve better performance and efficiency than a single computing device could provide.

With better performance and efficiency comes increased complexity. One source of increased complexity in distributed computing systems is due to data being partitioned among and processed at different nodes in a computing cluster. Various schemes exist to ensure fault tolerance, data consistency, and coordination between components of complex distributed computing systems.

### SUMMARY OF THE INVENTION

Aspects described herein relate to a fault tolerance scheme for preventing data loss when components of a distributed computing cluster fail. One example of such a component is a “DoAll” component in a dataflow graph (where a dataflow graph may be implemented as a processing component such as a networked device with a process running thereon) that interfaces with the distributed computing cluster. In general, a DoAll component causes the distributed computing cluster to process a collection of data stored in the distributed computing cluster. The collection of data is stored in a distributed fashion across multiple computing nodes (sometimes referred to as “data processors”) of the cluster. Processing of the collection in the cluster involves using a “ForAll” procedure to process all the data elements stored at the computing nodes by applying a function (e.g., f(( ) to all the data elements. The processed data is returned by the computing nodes to the DoAll component, which subsequently releases the processed data to downstream components in the dataflow graph.

In a situation where a component of the distributed computing system fails, processed data could be lost. For example, if a DoAll component fails, data processed by the nodes of the cluster but not delivered to the DoAll component may be lost. Aspects described herein implement an escrow scheme for storing processed data in an escrow buffer associated with the ForAll procedure. Processed data can be replayed from the escrow buffer (and not reprocessed) in the case of failure of the DoAll component. For large collections of data, the escrow buffer can become quite large. To mitigate the effects of large collections of data on the escrow buffer, the collection of data is over-partitioned at each computing node and the over-partitioned data is processed (and stored in escrow) one partition at a time, reducing the required size of the escrow buffer.

In an general aspect, a method for fault-tolerant processing of a number of data elements using a distributed computing cluster, the distributed computing cluster including a number of data processors associated with a corresponding number of data stores, includes storing the data elements in the distributed computing cluster, wherein the data elements are distributed across the data stores according to a number of partitions of data elements, processing data elements of a first set of partitions stored at a first data store using a first data processor to generate first result data for the data elements of the first set of partitions, sending the first result data from the distributed computing cluster to a consumer of the first result data (e.g., a dataflow graph including a consumer component, referred to as a “DoAll” component herein) outside the distributed computing cluster, and storing the first result data in a first buffer (sometimes referred to as an “escrow buffer” herein) located in the distributed computing cluster and associated with the first data processor until the consumer has persistently stored the first result data outside the distributed computing cluster.

Aspects may include one or more of the following features.

The processing may include applying a same function (f) to each data element of the number of data elements. The data elements may be over-partitioned in the cluster. The consumer may be a dataflow graph and more specifically, a DoAll component in a dataflow graph. The results may also be stored in another escrow buffer at DoAll component. The results may be over partitioned in the DoAll escrow buffer just like in the data engine escrow buffers.

The method may include removing the first result data from the first escrow buffer after the consumer has persistently stored all the result data associated with the first partition outside the distributed computing cluster. At least some data stores of the number of data stores may include two or more partitions of data elements of the number of data elements. The consumer may include a dataflow graph including a consumer component. The consumer component of the dataflow graph may include a second escrow buffer for storing result data, the method further including storing the first result data in the second escrow buffer. The first result data may be released from the second escrow buffer based on an indication that the computing cluster has persistently stored a state associated with the first result data. The method may include removing the first result data from the second escrow buffer after the consumer has released all result data for the first partition from the second escrow buffer and has persistently stored state information for the dataflow graph.

The method may include re-sending the first result data from the distributed computing cluster to the consumer based on a determination that the consumer encountered a fault before persistently storing the first result data outside the distributed computing cluster. Re-sending the first result data may include reading the first result data from the first escrow buffer associated with the first data processor.

The method may include determining that the first data processor encountered a fault and, based on that determination activating a replica of the first data processor based on a determination that the first data processor encountered a fault, and restoring the consumer to its state prior to receiving the first result data from the distributed computing cluster. The method may include processing data elements of the first set of partitions using the replica of the first data processor to generate regenerated result data for the data elements of the first set of partitions, sending the regenerated result data from the distributed computing cluster to the consumer, and storing the regenerated result data in the first escrow buffer located in the distributed computing cluster and associated with the replica of the first data processor until the consumer has persistently stored the regenerated result data outside the distributed computing cluster.

Processing the data elements of the first set of partitions may include applying a same function to each data element. The processing may include marking each processing result in the first result data with a partition number and a value of a counter associated with the cluster. The method may include, in response to a predefined number of data elements having finished processing in the distributed computing cluster, incrementing a counter associated with the cluster, and sending a message to the processing component, the message indicating that a checkpoint indicated by the counter has been reached. The method may include determining that the checkpoint has been reached based on a number of data elements having finished processing by the data processors since a last incrementation of the counter or determining that the checkpoint has been reached by determining whether a predetermined time interval has lapsed since a last incrementation of the counter.

The method may include receiving, at the first data processor, a message from the processing component indicating that all data elements associated with a current value of the counter having been removed from the processing component and in response to receiving the message, removing the first result data from the first buffer. The method may include receiving, at the first data processor, a message from the processing component requesting the first data processor to resend the first result data to the processing component and sending, by the first data processor, the first result data to the processing component.

The method may include determining, by the first data processor, that the second data processor is subject to failure of operation, in particular wherein the failure of operation is detected based on a message indicating the failure being sent from the second data engine or the second data engine failing to respond to a message regularly sent by the first data processor and responsive to determining the failure, replicating the second data processor. Replicating the second data processor may include identifying, by the first data processor, a further data processor in the number of data processors, in particular by identifying a data processor that responds to a message within a threshold time and/or that reports available capacity upon request and sending a message to the identified data processor, the message requesting the identified data processor to update its data elements according to a state reflected by a previous value of the first counter, the data elements associated with a partition previously assigned to the second data processor.

In another general aspect, a system for fault-tolerant processing of a number of data elements using a distributed computing cluster, the distributed computing cluster including a number of data processors associated with a corresponding number of data stores includes a number of data stores, for storing the number of data elements, wherein the number of data elements is distributed across the number of data stores according to a number of partitions of data elements, a number of data processors for processing data elements, the number of data processors including a first processor for processing a first set of partitions of the number of partitions stored at a first data store of the number of data stores to generate first result data for the data elements of the first set of partitions, an output for sending the first result data from the distributed computing cluster to a consumer of the first result data outside the distributed computing cluster, and a first escrow buffer located in the distributed computing cluster and associated with the first data processor for storing the first result data until the consumer has persistently stored the first result data outside the distributed computing cluster.

In another general aspect, a computer-readable medium stores software in a non-transitory form, the software including instructions for causing a computing system to process, in a fault-tolerant manner, a number of data elements using a distributed computing cluster, the distributed computing cluster including a number of data processors associated with a corresponding number of data stores. The instructions cause the computing system to store the number of data elements in the distributed computing cluster, wherein the number of data elements is distributed across the number of data stores according to a number of partitions of data elements, process data elements of a first set of partitions of the number of partitions stored at a first data store of the number of data stores using a first data processor of the number of data processors to generate first result data for the data elements of the first set of partitions, send the first result data from the distributed computing cluster to a consumer of the first result data outside the distributed computing cluster, and store the first result data in a first escrow buffer located in the distributed computing cluster and associated with the first data processor until the consumer has persistently stored the first result data outside the distributed computing cluster.

In another general aspect, a system is configured for fault-tolerant processing of a number of data elements using a distributed computing cluster, the distributed computing cluster including a number of data processors associated with a corresponding number of data stores. The system includes means for storing the number of data elements, wherein the number of data elements is distributed across the number of data stores according to a number of partitions of data elements, means for processing data elements, the number of data processors including a first processor for processing a first set of partitions of the number of partitions stored at a first data store of the number of data stores to generate first result data for the data elements of the first set of partitions, means for sending the first result data from the distributed computing cluster to a consumer of the first result data outside the distributed computing cluster, and storage means, located in the distributed computing cluster and associated with the first data processor for storing the first result data until the consumer has persistently stored the first result data outside the distributed computing cluster.

Aspects may have one or more of the following advantages.

Aspects advantageously implement faulting tolerance in a distributed computing system by using an escrow scheme to store result data until it is certain that the result data will not need to be replayed due to failure of components in the system (e.g., dataflow graph components or data processing components in a computing cluster). Aspects achieve the further advantage of reducing the size of escrow buffers for large collections of data, where the escrow buffers can become quite large. Aspects mitigate the effects of large collections of data on the escrow buffers by over-partitioning the collection of data at each computing node and processing the over-partitioned (which is also stored in escrow buffers) one partition at a time, reducing the required size of the escrow buffers.

Other features and advantages of the invention are apparent from the following description and from the claims.

### BRIEF DESCRIPTION OF THE DRAWINGS

FIG. 1 is a data processing system.

FIG. 2 shows a first step in a DoAll component in a dataflow graph using a distributed computing cluster to process a collection of data stored in the distributed computing cluster.

FIG. 3 shows a second step in the DoAll component using the distributed computing cluster to process the collection of data.

FIG. 4 shows a third step in the DoAll component using the distributed computing cluster to process the collection of data.

FIG. 5 shows a fourth step in the DoAll component using the distributed computing cluster to process the collection of data.

FIG. 6 shows a fifth step in the DoAll component using the distributed computing cluster to process the collection of data.

FIG. 7 shows a sixth step in the DoAll component using the distributed computing cluster to process the collection of data.

FIG. 8 shows a seventh step in the DoAll component using the distributed computing cluster to process the collection of data.

FIG. 9 shows an eighth step in the DoAll component using the distributed computing cluster to process the collection of data.

FIG. 10 shows the DoAll component failing during a ninth step of processing the collection of data.

FIG. 11 shows recovery from the failure of the DoAll component by replaying the results determined in the ninth step of FIG. 10.

FIG. 12 shows a tenth step in the DoAll component using the distributed computing cluster to process the collection of data.

FIG. 13 shows an eleventh step in the DoAll component using the distributed computing cluster to process the collection of data.

FIG. 14 shows a data engine failing during a twelfth step of processing the collection of data.

FIG. 15 shows recovery from the failure of the data engine during the twelfth step of processing the collection of data.

FIG. 16 shows a thirteenth step in the DoAll component using the distributed computing cluster to process the collection of data.

FIG. 17 shows a fourteenth step in the DoAll component using the distributed computing cluster to process the collection of data.

FIG. 18 shows a fifteenth step in the DoAll component using the distributed computing cluster to process the collection of data.

FIG. 19 shows a sixteenth and final step of the DoAll component using the distributed computing cluster to process the collection of data.

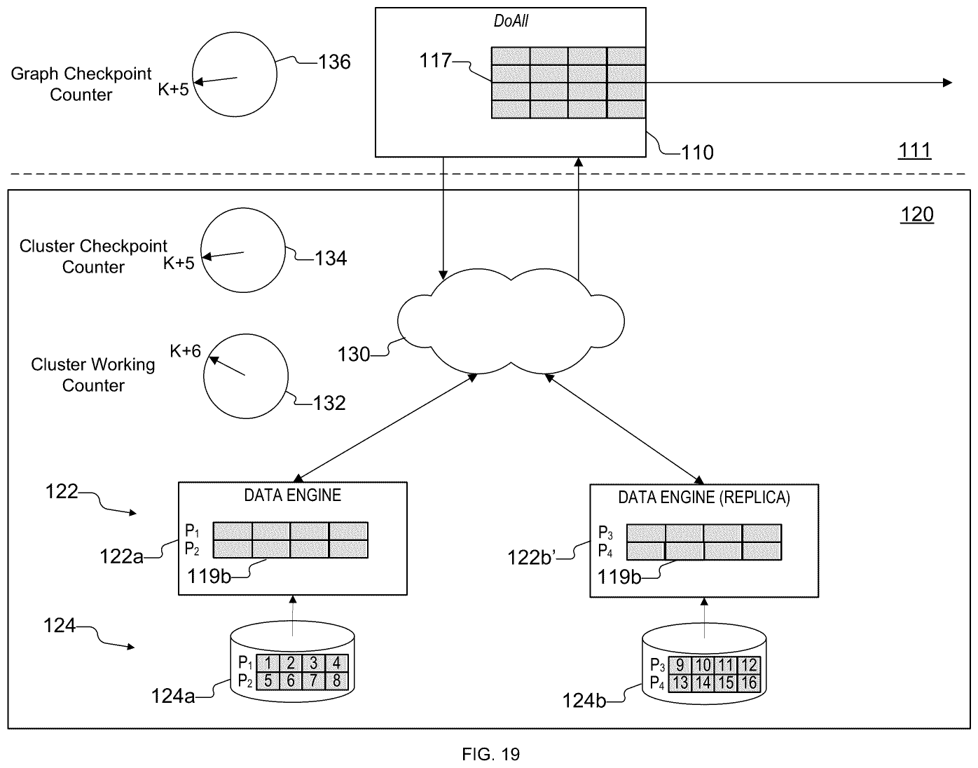

### DETAILED DESCRIPTION

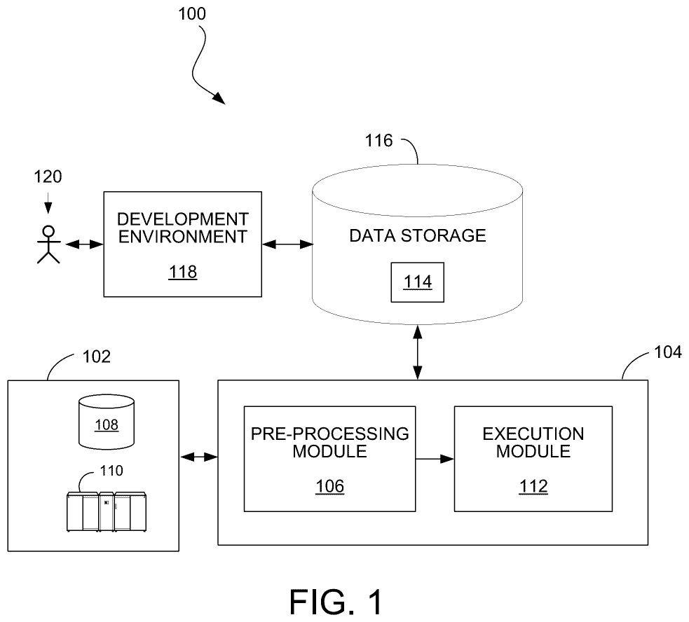

FIG. 1 shows an example of a data processing system 100 in which computing cluster management techniques can be used. The system 100 includes a data source 102 that may include one or more sources of data such as storage devices or connections to online data streams, each of which may store or provide data in any of a variety of formats (e.g., database tables, spreadsheet files, flat text files, or a native format used by a mainframe). An execution environment 104 includes a pre-processing module 106 and an execution module 112. The execution environment 104 may be hosted, for example, on one or more general-purpose computers under the control of a suitable operating system, such as a version of the UNIX operating system. For example, the execution environment 104 can include a multiple-node parallel computing environment including a configuration of computer systems using multiple processing units (e.g., central processing units, CPUs) or processor cores, either local (e.g., multiprocessor systems such as symmetric multi-processing (SMP) computers), or locally distributed (e.g., multiple processors coupled as clusters or massively parallel processing (MPP) systems, or remote, or remotely distributed (e.g., multiple processors coupled via a local area network (LAN) and/or wide-area network (WAN)), or any combination thereof.

The pre-processing module 106 can perform any configuration tasks that may be needed before a program specification (e.g., the graph-based program specification described below) is executed by the execution module 112. The pre-processing module 106 can configure the program specification to receive data from a variety of types of systems that may embody the data source 102, including different forms of database systems. The data may be organized as records having values for respective fields (also called “attributes”, “rows” or “columns”), including possibly null values. When first configuring a computer program, such as a data processing application, for reading data from a data source, the pre-processing module 106 typically starts with some initial format information about records in that data source. The computer program may be expressed in the form of the dataflow graph as described herein. In some circumstances, the record structure of the data source may not be known initially and may instead be determined after analysis of the data source or the data. The initial information about records can include, for example, the number of bits that represent a distinct value, the order of fields within a record, and the type of value (e.g., string, signed/unsigned integer) represented by the bits.

Storage devices providing the data source 102 may be local to the execution environment 104, for example, being stored on a storage medium connected to a computer hosting the execution environment 104 (e.g., hard drive 108), or may be remote to the execution environment 104, for example, being hosted on a remote system (e.g., mainframe 110) in communication with a computer hosting the execution environment 104, over a remote connection (e.g., provided by a cloud computing infrastructure).

The execution module 112 executes the program specification configured and/or generated by the pre-processing module 106 to read input data and/or generate output data. The output data 114 may be stored back in the data source 102 or in a data storage system 116 accessible to the execution environment 104, or otherwise used. The data storage system 116 is also accessible to a development environment 118 in which a developer 120 is able to develop applications for processing data using the execution module 112.

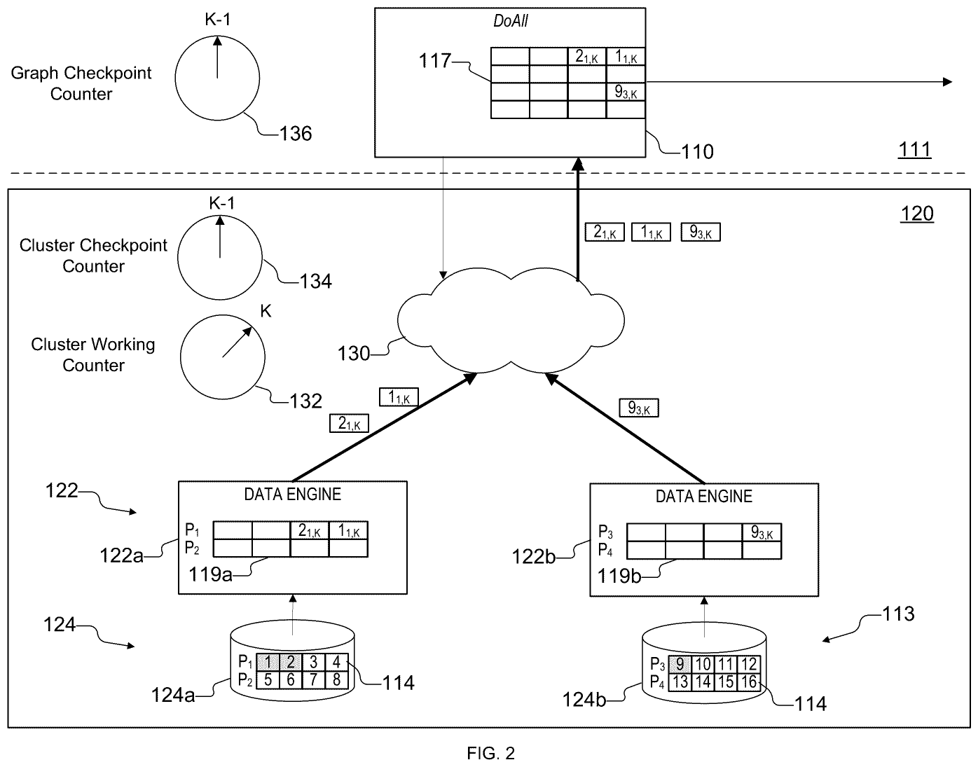

Very generally, some computer programs (e.g., dataflow graphs) for processing data using the execution module 112 include a component that accesses a computing cluster. For example, and as is described in greater detail below, referring to FIG. 2, a DoAll component 110 in a dataflow graph 111 interacts with a computing cluster 120 to process a collection 113 of data elements 114 (e.g., records) stored in the computing cluster 120. The results of that processing are returned to the DoAll component 110, which then sends the results downstream to one or more other components of the dataflow graph 111.

### 1 DATAFLOW GRAPH

For the sake of simplicity, the dataflow graph 111 is only partially shown in FIG. 2 (i.e., as an area above the dashed line), and it should be noted that the dataflow graph 111 typically includes additional components. More generally, the graph-based program specification may be implemented, for example, as a dataflow graph as described in U.S. Pat. Nos. 5,966,072, 7,167,850, or 7,716,630, or a data processing graph as described in U.S. Publication No. 2016/0062776. Such dataflow graph based program specifications generally include computational components corresponding to nodes (vertices) of a graph coupled by data flows corresponding to links (directed edges) of the graph (called a “dataflow graph”). A downstream component connected to an upstream component by a data flow link receives an ordered stream of input data elements and processes the input data elements in the received order, optionally generating one or more corresponding flows of output data elements. In some examples, each component is implemented as a process that is hosted on one of typically multiple computer servers. Each computer server may have multiple such component processes active at any one time, and an operating system (e.g., Unix) scheduler shares resources (e.g., processor time, and/or processor cores) among the components hosted on that server. In such an implementation, data flows between components may be implemented using data communication services of the operating system and data network connecting the servers (e.g., named pipes, TCP/IP sessions, etc.). A subset of the components generally serve as sources and/or sinks of data from the overall computation, for example, to and/or from data files, database tables, and external data flows. After the component processes and data flows are established, for example, by a coordinating process, data then flows through the overall computation system implementing the computation expressed as a graph generally governed by the availability of input data at each component and scheduling of computing resources for each of the components.

### 2 COMPUTING CLUSTER

The computing cluster 120 includes a number of data engines 122 (sometimes referred to as “data processors”) coupled by a communication network 130 (illustrated in FIG. 2 as a “cloud,” and can have various interconnection topologies, such as start, shared medium, hypercube, etc.). In some implementations, each of the data engines 122 is hosted on a distinct computing resource (e.g., a separate computer server, a separate core of a multi-core server, etc.). It should be understood that the data engines represent roles within the cluster, and that in some embodiments, the multiple roles may be hosted on one computing resource, and a single role may be distributed over multiple computing resources.

In the example of FIG. 2, two data engines (a first data engine 122a and a second data engine 122b) are shown for simplicity, but it should be understood that the computing cluster 120 generally has more than two data engines. Each data engine has access to a corresponding data store 124, where the first data engine 122a has access to a first data store 124a and the second data engine 122b has access to a second data store 124b. Each data store 124a, 124b stores a part of the collection 113 of data elements 114. In some examples, the pre-processing module 106 distributes the collection 113 across the data stores such that each data store stores roughly and equal number of data elements. In some examples, the data elements are distributed in a particular order to increase efficiency of processing (e.g., interleaved among the data stores or stored in order across the data stores). In other examples, the execution module 112 distributes the collection 113 across the data stores at runtime.

In operation, when the DoAll component 110 instructs the computing cluster 120 to process the collection 113, a “ForAll” process (not shown) is instantiated at each data engine 122. The ForAll instantiated at a given data engine 122 (where the data engines are chosen by the execution module 112, for example, based on availability) processes the part of the collection 113 stored in its corresponding data store 124a, 124b (e.g., by applying a function f( ) to data elements in the collection). The results of the processing are returned to the DoAll component 110 via the communication network 130.

A checkpointing scheme is used to provide fault tolerance in both the computing cluster 120 and the dataflow graph 111. In some examples, a checkpoint includes a predetermined number of data elements having been processed. In other examples, the checkpoint is associated with a predetermined processing interval. In some examples, the checkpointing scheme is coordinated using a number of counters, including a cluster working counter 132, a cluster checkpoint counter 134, and a graph checkpoint counter 136. The cluster working counter 132 leads the other counters and represents a time interval in which the data engines 122 are currently processing data elements of the collection 113. The cluster checkpoint counter 134 lags the cluster working time 132 by at least one “tick” and represents a time up to which the cluster has persistently stored its state. In the event of a failure in the cluster, the cluster is able to roll its state back to a state associated with the cluster checkpoint counter 134 and resume execution from that state. The graph checkpoint counter 136 also lags the cluster working counter and represents a time up to which the dataflow graph 111 has persistently stored its state. In the event of a failure of the dataflow graph 111, the graph is able to roll its state back to a state associated with the graph checkpoint counter 136 and resume execution from that state. Further details of the checkpointing system can be found in U.S. Pat. No. 11,288,284, the entire contents of which are incorporated herein by reference.

In this application, the checkpoint counters are used to mark when result data was generated and to determine when that result data can be released from escrow buffers and/or deleted, as is described in greater detail below (e.g., by reading the values of the various counters and comparing those values with the counter values assigned to result data). In the description below, for the sake of simplicity, the counter values are not explicitly described as being read and compared to the counter values of result data, but it is that reading and comparison that decides when result data can be released and/or removed from escrow buffers.

### 3 ESCROW SCHEME

The dataflow graph 111 and the computing cluster 120 work together to implement an escrow scheme that ensures any results returned to the dataflow graph 111 by the DoAll component 110 are stored until the dataflow graph 111 will never need those results replayed to it (i.e., all results for a particular checkpoint returned to the dataflow graph from the DoAll component are committed, e.g., committed to other entities and reported by the DoAll component as being no longer required to be stored in the distributed computing cluster). As part of the escrow scheme, the data engines 122 each include a ForAll escrow buffer 119 (sometimes referred to as a “ForAll buffer” or simply a “buffer”) that temporarily stores the results of the ForAll process processing the part of the collection 113 stored in the data engine's corresponding data store 124. The DoAll component 110 includes a DoAll escrow buffer 117 (sometimes referred to as a “DoAll buffer” or simply a “buffer”) that temporarily stores the results of processing elements of the collection 113.

Processing results stored in the escrow buffers 117, 119 are replayed if the DoAll component 110 or one of the data engines 122 fails, and recovery is required. Once processing results are persistently stored and will never need to be replayed from the escrow buffers, results are removed from the escrow buffers. This removal of processing results from the escrow buffers is also coordinated using the counters 132, 134, 136.

In the simple example shown in FIG. 2, the collection 113 of data elements 114 is partitioned across the two data engines 122, where a first part of the collection 113 is stored in the first data store 124a available to the first data engine 122a and a second part of the collection 113 is stored in the second data store 124b available to the second data engine 122b. The respective parts of the collection stored in the data stores are “over-partitioned” in that each part of the collection is stored in the data stores as a number of sub-partitions. For example, the number of data elements in each sub-partition can be as large as the number of data elements that can be processed in parallel by the respective data engine. In other examples, each sub-partition my include as few as one data element. In the first data store 124a, a first part of the collection is stored as two sub-partitions, P₁ and P₂. In the second data store 124b, a second part of the collection is stored as two sub-partitions, P₃ and P₄.

The ForAll process instantiated at each data engine 122 processes the data engine's part of the collection 113 one sub-partition at a time and stores the results in the data engine's ForAll escrow buffer 116, according to the sub-partition. Once results for a sub-partition stored in a data engine's ForAll escrow buffer 116 are no longer needed, they are removed from the ForAll escrow buffer. On average, each data engine 122 stores one sub-partition of results in its ForAll escrow buffer at any given time, reducing a total amount of storage necessary to maintain the ForAll escrow buffers 116. This is due at least in part to the fact that result data that no longer needs to be stored in the escrow buffers is promptly cleared from the buffers, as is described and illustrated below.

As is illustrated in greater detail below, by over-partitioning the collection of data 113, the sizes of the escrow buffers (which otherwise might grow so large that they cannot be feasibly maintained) are maintained at a manageable size without any reduction in processing capacity or performance.

### 3.1 EXAMPLE

Continuing to refer to FIG. 2, a simple example illustrates processing the collection 113 of data elements 114 while using the escrow scheme. It should be appreciated that the example below is provided to facilitate an understanding of the scheme and that typical implementations of the scheme involve significantly more data and complexity than the example.

In FIG. 2, the DoAll component 110 has already requested that the computing cluster 120 process the collection 113 of data elements 114 and the data engines 122 have each instantiated a ForAll process. The cluster working counter 132 has a value of K and both the cluster checkpoint counter 134 and the graph checkpoint counter have a value of K−1 (where K represents an arbitrary time when the example begins).

The first data engine 122a reads data elements 1 and 2 from the first sub-partition P₁ of the collection 113. It applies some function, f( ) to each of the data elements to generate processing results. In some examples, each processing result is marked with a sub-partition number and a value of the cluster working counter 132. The results of processing data elements 1 and 2 are referred to as “f(1_{1,K})” and “f(2_{1,K})” because both results are associated with sub-partition P₁ and the value K of the cluster working counter 132. Results f(1_{1,K}) and f(2_{1,K}) are stored in the ForAll escrow buffer 116a of the first data engine 122a, associated with the first sub-partition, P₁. Data elements 1 and 2 are shaded gray in the first data store 124a to indicate that they have been read and processed by the first data engine 122a. Note that an abbreviated notation is used to refer to the results in the figures, where “1_{1,K}” corresponds to the result “f(1_{1,K})” and “2_{1,K}” corresponds to the result “f(2_{1,K}).” This notation is used throughout the remainder of the application.

Similarly, the second data engine 122b reads data element 9 from the third sub-partition, P₃ of the collection 113 and applies the function, f( ) to the data element to generate the processing result referred to as “f(9_{3,K}).” Result f(9_{3,K}) is stored in the ForAll escrow buffer 116b of the second data engine 122b, associated with the third sub-partition, P₃. Data element 9 is shaded gray in the second data store 124b to indicate that it has been read and processed by the second data engine 122b.

Results f(1_{1,K}), f(2_{1,K}), and f(9_{3,K}) are sent out to respective data engines 122a and 122b of the computing cluster 120 to the DoAll component 110, where they are stored in the DoAll escrow buffer 117 in association with their respective sub-partitions.

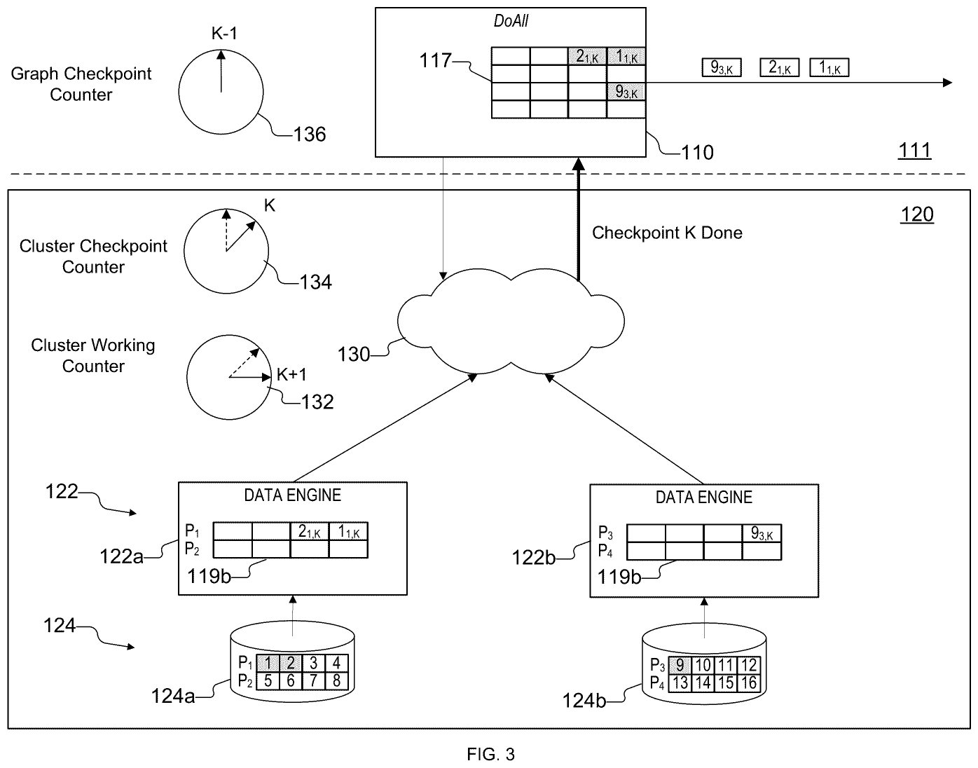

Referring to FIG. 3, when the computing cluster 120 completes persistently storing state for cluster checkpoint K, the value of the cluster checkpoint counter 132 is incremented from K−1 to K and the cluster working counter 134 is incremented from K to K+1. A “Checkpoint K Done” message is sent from the computing cluster 120 to the DoAll component 110. In one embodiment, the message is sent by the data engine that processed the last data elements pertaining to the checkpoint, in this case, the message is also sent to other data engines in the cluster to notify them that the message has been sent and does not need to be sent again. In another embodiment, data engines notify a predetermined data engine about the data elements they have processed, the predetermined data engine sends the aforementioned message to the processing component when the checkpoint has been reached. A checkpoint is reached when a predetermined time interval has passed or a predetermined number of data elements has been processed.

Once the DoAll component 110 is informed that checkpoint K is complete in the computing cluster 120, it can safely release all results tagged with checkpoint K from the DoAll escrow buffer 117. In this case, the DoAll component 110 releases results f(1_{1,K}), f(2_{1,K}), and f(9_{3,K}), sending the results to downstream components in the dataflow graph 111. The released results are shaded gray in the DoAll escrow buffer 117 to indicate that they have been released from the escrow buffer.

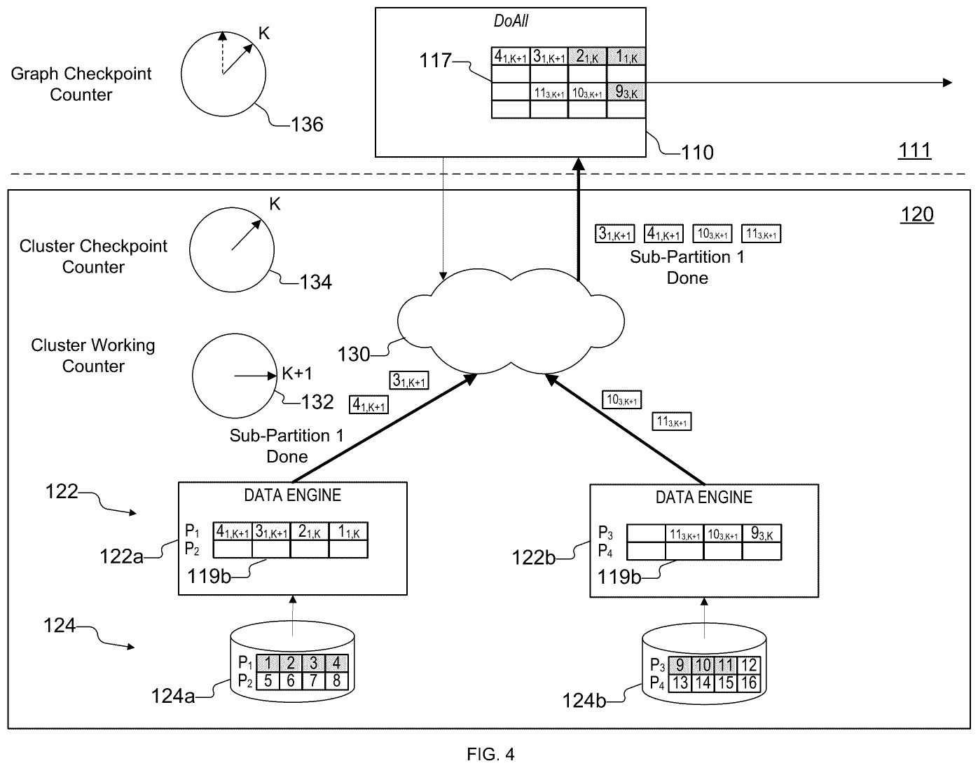

Referring to FIG. 4, the first data engine 122a reads data elements 3 and 4 from the first sub-partition P₁ of the collection 113 and applies the function, f( ) to each of the data elements to generate processing results “f(3_{1,K+1})” and “f(4_{1,K+1}).” Results f(3_{1,K+1}) and f(4_{1,K+1}) (where K+1 is the read from the current value of the cluster working counter) are stored in the ForAll escrow buffer 116a of the first data engine 122a, associated with the first sub-partition, P₁. Data elements 3 and 4 are shaded gray in the first data store 124a to indicate that they have been read and processed by the first data engine 122a. Because all the data elements of the first sub-partition, P₁ have been processed, the first data engine 122a issues a “Sub-Partition 1 Done” message.

The second data engine 122b reads data elements 10 and 11 from the third sub-partition, P₃ of the collection 113 and applies the function, f( ) to the data element to generate the processing results f(10_{3,K+1}) and f(11_{3,K+1}). Results f(10_{3,K+1}) and f(11_{3,K+1}) are stored in the ForAll escrow buffer 116b of the second data engine 122b, associated with the third sub-partition, P₃. Data elements 10 and 11 are shaded gray in the second data store 124b to indicate that they have been read and processed by the second data engine 122b.

When the dataflow graph 111 completes persistently storing state for the graph's checkpoint K−1, the graph checkpoint counter 136 is incremented from K−1 to K.

Finally, the processing results f(3_{1,K+1}), f(4_{1,K+1}), f(10_{3,K+1}), and f(11_{3,K+1}) are sent out of the computing cluster 120 to the DoAll component 110, where they are stored in the DoAll escrow buffer 117 in association with their respective sub-partitions. The “Sub-Partition 1 Done” message is also sent to the DoAll component 110, where it is stored for later use.

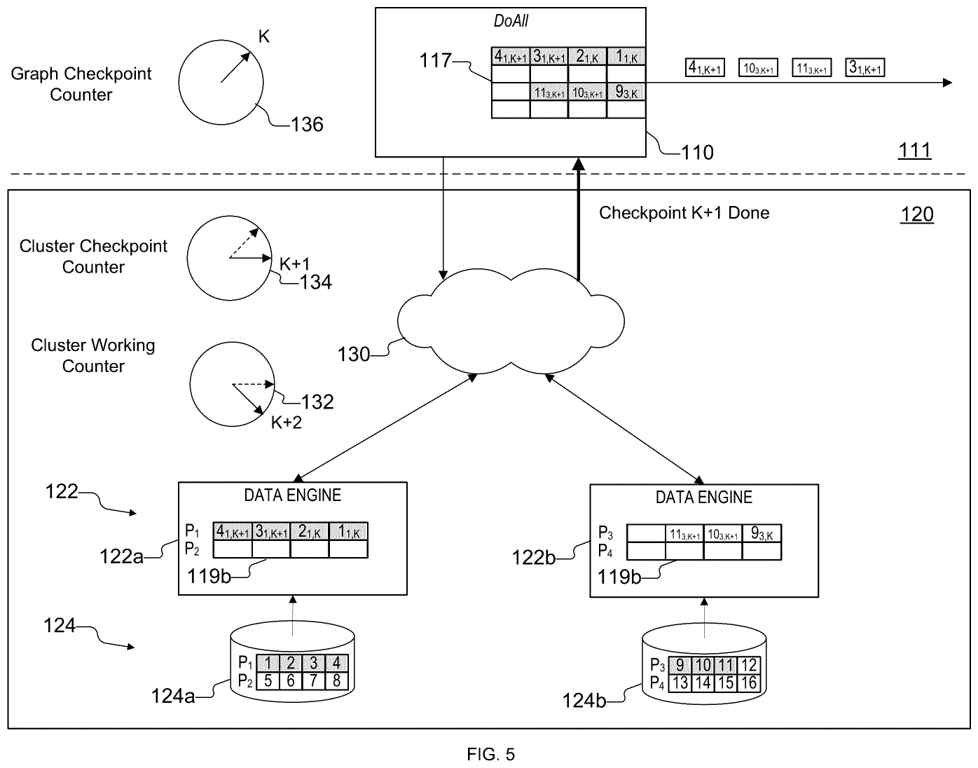

Referring to FIG. 5, when the computing cluster 120 completes persistently storing state for cluster checkpoint K+1, the value of the cluster checkpoint counter 132 is incremented from K to K+1 and the cluster working counter 134 is incremented from K+1 to K+2. A “Checkpoint K+1 Done” message is sent from the computing cluster 120 to the DoAll component 110. Once the DoAll component 110 is informed that checkpoint K+1 is complete in the computing cluster 120, it can safely release all results tagged with checkpoint K+1 from the DoAll escrow buffer 117. In this case, the DoAll component 110 releases results f(4_{1,K+1}), f(10_{3,K+1}), f(11_{3,K+1}), and f(3_{1,K+1}), sending the results to downstream components in the dataflow graph 111. The released results are shaded gray in the DoAll escrow buffer 117 to indicate that they have been released from the escrow buffer.

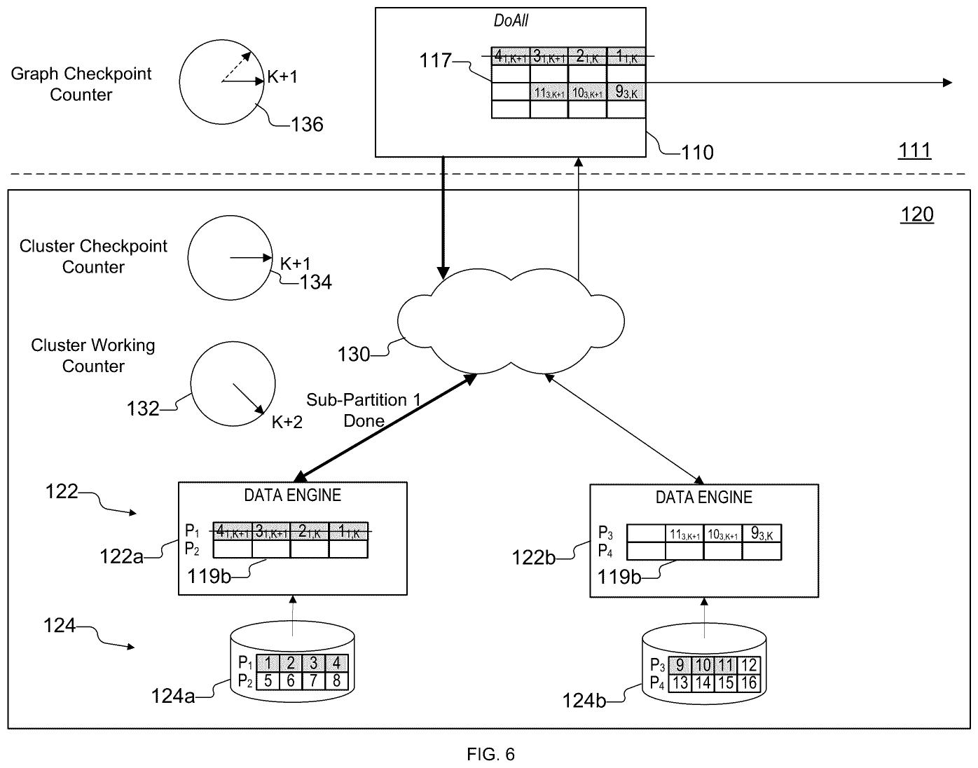

Referring to FIG. 6, when the dataflow graph 111 completes persistently storing state for the graph's checkpoint K, the graph checkpoint counter 136 is incremented from K to K+1. The results for sub-partition 1 are removed from the DoAll escrow buffer 117 because they will never need to be replayed from the DoAll escrow buffer 117 (i.e., the dataflow graph's state is persistently stored up to graph checkpoint K+1 and all the results for sub-partition 1 have been computed and provided to components downstream from the DoAll component 111). In some examples, the results to be removed are determined by the DoAll component 111 based on the partition information stored along with the results in the DoAll escrow buffer 117.

The DoAll component 111 sends a “Sub-Partition 1 Done” message into the computing cluster 120 to the first data engine 122a. Upon receiving the Sub-Partition 1 Done message, the first data engine 122a removes the results for sub-partition 1 from the first DoAll escrow buffer 116a.

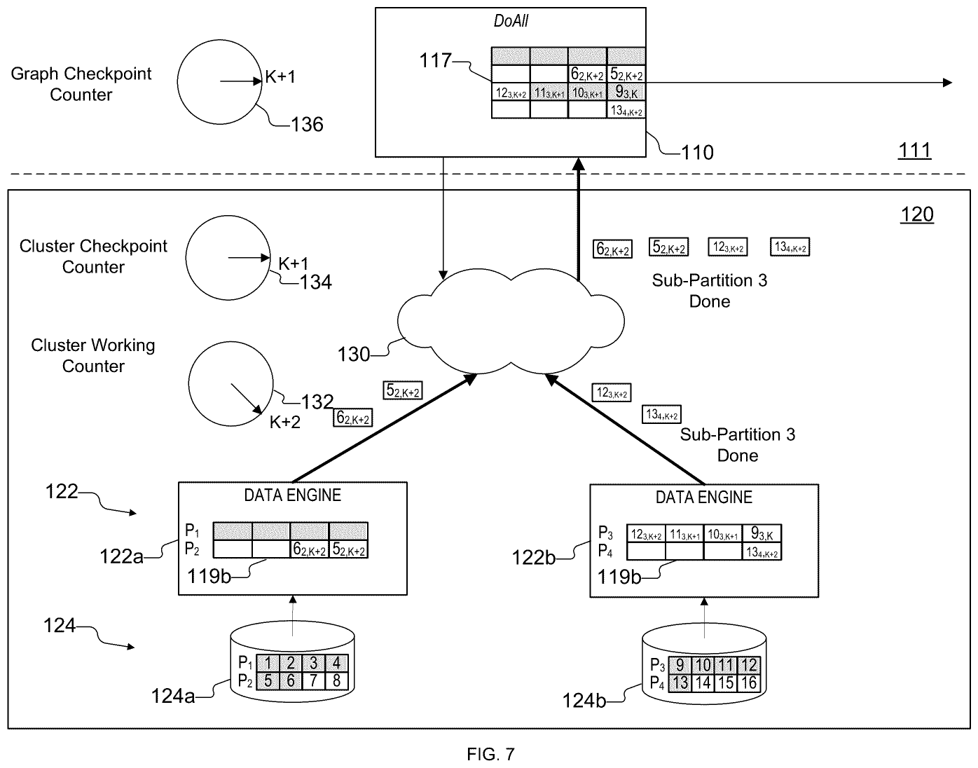

Referring to FIG. 7, the first data engine 122a reads data elements 5 and 6 from the second sub-partition P₂ of the collection 113 and applies the function, f( ) to each of the data elements to generate processing results “f(5_{2,K+2})” and “f(6_{2,K+2}).” Results f(5_{2,K+2}) and f(6_{2,K+2}) are sent to the DoAll component 110 and stored in the ForAll escrow buffer 116a of the first data engine 122a, associated with the second sub-partition, P₂. Data elements 5 and 6 are shaded gray in the first data store 124a to indicate that they have been read and processed by the first data engine 122a.

The second data engine 122b reads data elements 12 and 13 from the third and fourth sub-partitions, P₃ and P₄, respectively, and applies the function, f( ) to the data elements to generate the processing results f(12_{3,K+2}) and f(13_{4,K+2}). Results f(12_{3,K+2}) and f(13_{4,K+2}) are stored in the ForAll escrow buffer 116b of the second data engine 122b, associated with the third and fourth sub-partitions, P₃ and P₄, respectively. Data elements 12 and 13 are shaded gray in the second data store 124b to indicate that they have been read and processed by the second data engine 122b. Because all the data elements of the third sub-partition, P₃ have been processed, the second data engine 122b issues a “Sub-Partition 3 Done” message.

The processing results f(5_{2,K+2}), f(6_{2,K+2}), f(12_{3,K+2}) and f(13_{4,K+2}) are sent out of the computing cluster 120 to the DoAll component 110, where they are stored in the DoAll escrow buffer 117 in association with their respective sub-partitions. The “Sub-Partition 3 Done” message is also sent to the DoAll component 110, where it is stored for later use.

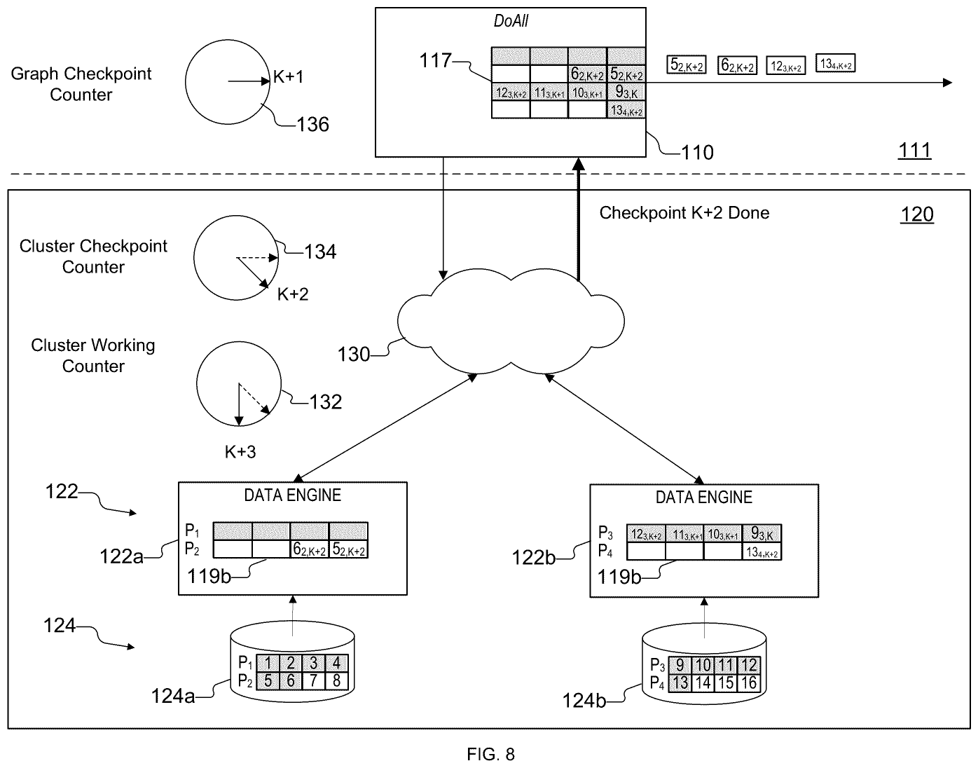

Referring to FIG. 8, when the computing cluster 120 completes persistently storing state for cluster checkpoint K+2, the value of the cluster checkpoint counter 132 is incremented from K+1 to K+2 and the cluster working counter 134 is incremented from K+2 to K+3. A “Checkpoint K+2 Done” message is sent from the computing cluster 120 to the DoAll component 110. Once the DoAll component 110 is informed that checkpoint K+2 is complete in the computing cluster 120, it can safely release all results tagged with checkpoint K+2 from the DoAll escrow buffer 117. In this case, the DoAll component 110 releases results f(5_{2,K+2}), f(6_{2,K+2}), f(12_{3,K+2}) and f(13_{4,K+2}), sending the results to downstream components in the dataflow graph 111. The released results are shaded gray in the DoAll escrow buffer 117 to indicate that they have been released from the escrow buffer.

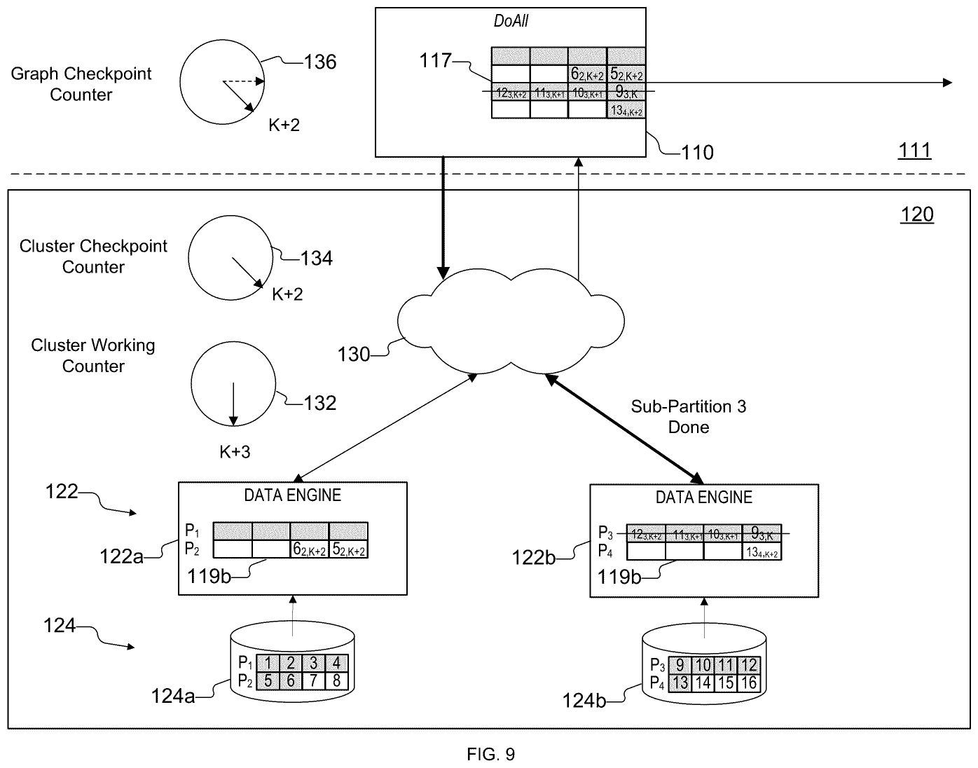

Referring to FIG. 9, when the dataflow graph 111 completes persistently storing state for the graphs checkpoint K+1, the graph checkpoint counter 136 is incremented from K+1 to K+2. The results for the third sub-partition, P₃ are removed from the DoAll escrow buffer 117 because they will never need to be replayed from the DoAll escrow buffer 117 (i.e., the data flow graph's state is persistently stored up to graph checkpoint K+2 and all the results for sub-partition 1 have been computed and provided to components downstream from the DoAll component 111).

The DoAll component 111 sends a “Sub-Partition 3 Done” message into the computing cluster 120 to the second data engine 122b. Upon receiving the Sub-Partition 3 Done message, the second data engine 122b removes the results for sub-partition 3 from the second ForAll escrow buffer 116b.

### 4 DOALL FAILURE AND RECOVERY

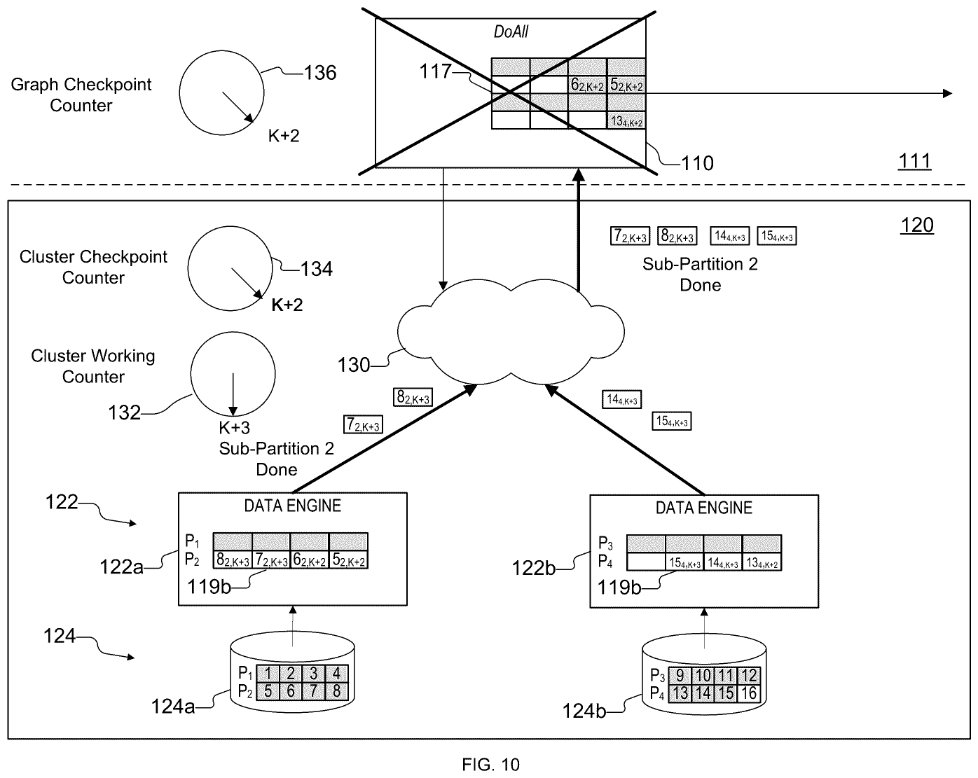

Referring to FIG. 10, the first data engine 122a reads data elements 7 and 8 from the second sub-partition, P₂ of the collection 113. It applies the function, f( ) to each of the data elements to generate processing results “f(7_{2,K+3})” and “f(8_{2,K+3}).” Results f(7_{2,K+3}) and f(8_{2,K+3}) are stored in the ForAll escrow buffer 116a of the first data engine 122a, associated with the second sub-partition, P₂. Data elements 7 and 8 are shaded gray in the first data store 124a to indicate that they have been read and processed by the first data engine 122a. Because all the data elements of the second sub-partition, P₂ have been processed, the first data engine 122a issues a “Sub-Partition 2 Done” message.

The second data engine 122b reads data elements 14 and 15 from the fourth sub-partition, P₄ and applies the function, f( ) to the data elements to generate the processing results f(14_{4,K+3}) and f(15_{4,K+3}). Results f(14_{4,K+3}) and f(15_{4,K+3}) are stored in the ForAll escrow buffer 116b of the second data engine 122b, associated with the fourth sub-partition, P₄. Data elements 14 and 15 are shaded gray in the second data store 124b to indicate that they have been read and processed by the second data engine 122b.

The processing results f(7_{2,K+3}), f(8_{2,K+3}), f(14_{4,K+3}), and f(15_{4,K+3}), and the Sub-Partition 2 Done message are sent out of the computing cluster 120 to the DoAll component 110, but before the processing results and Sub-Partition 2 Done message reach the DoAll component 110, the dataflow graph 111 fails.

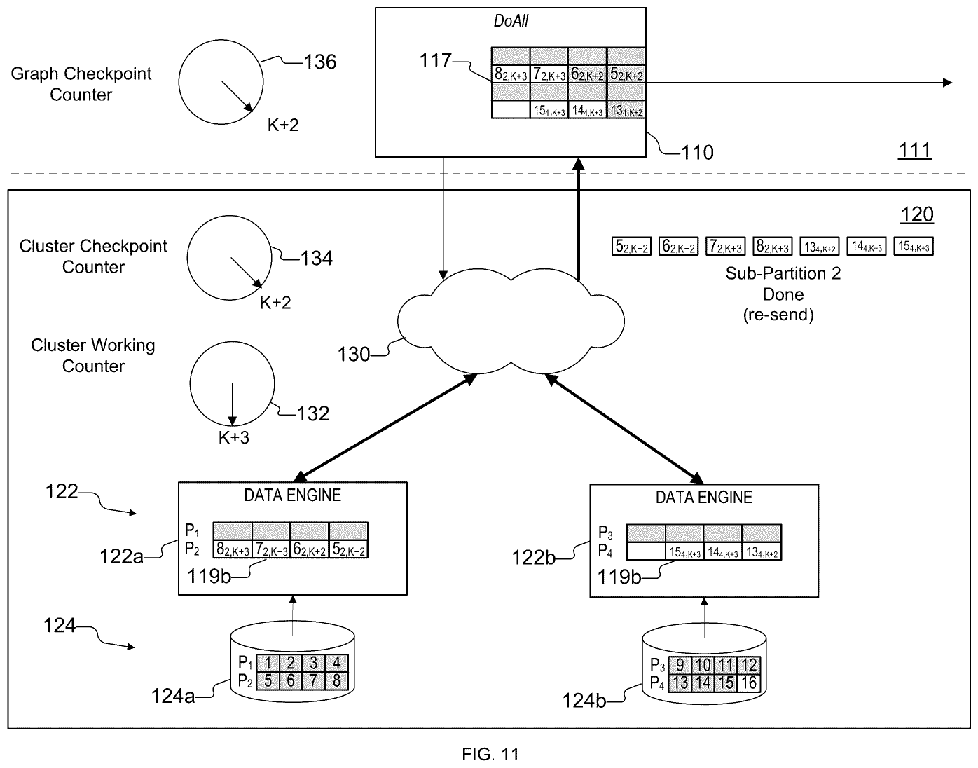

Referring to FIG. 11, the dataflow graph 111 restarts and recovers its state to graph checkpoint K+2. As part of the recovery, the DoAll component 110 causes the data engines 122 in the computing cluster 120 to replay the results stored in their respective ForAll escrow buffers 116. In some examples, the DoAll component 110 does so by sending a message to the data engines 122 requesting that the data engines replay their respective result data. In the example of FIG. 11, all the results stored in the first ForAll escrow buffer 116a (i.e., f(5_{2,K+2}), f(6_{2,K+2}), f(7_{2,K+3}), and f(8_{2,K+3})) and all the results stored in the second ForAll escrow buffer 116b (i.e., f(13_{4,K+2}), f(14_{4,K+3}), and f(15_{4,K+3})) are resent to the DoAll component 110. The Sub-Partition 2 Done message is also reissued because all the data elements of the second sub-partition, P₂ have been processed.

The DoAll component 110 receives the processing results f(5_{2,K+2}), f(6_{2,K+2}), f(7_{2,K+3}), f(8_{2,K+3}), f(13_{4,K+2}), f(14_{4,K+3}), and f(15_{4,K+3}) and stores the results in the DoAll escrow buffer 117 in association with their respective sub-partitions. The Sub-Partition 2 Done message is also received by the DoAll component 110, where it is stored for later use.

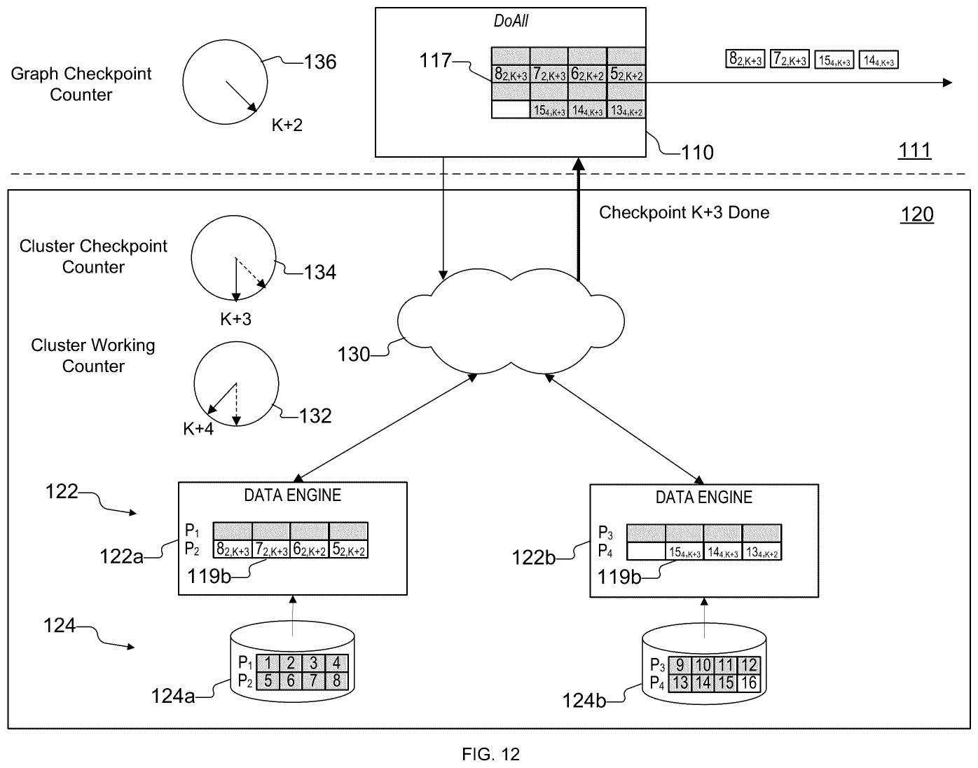

Referring to FIG. 12, when the computing cluster 120 completes persistently storing state for cluster checkpoint K+3, the value of the cluster checkpoint counter 132 is incremented from K+2 to K+3 and the cluster working counter 134 is incremented from K+3 to K+4. A “Checkpoint K+3 Done” message is sent from the computing cluster 120 to the DoAll component 110. Once the DoAll component 110 is informed that checkpoint K+3 is complete in the computing cluster 120, it can safely release all results tagged with checkpoint K+3 (or earlier) from the DoAll escrow buffer 117. In this case, the DoAll component 110 releases results f(7_{2,K+3}), f(8_{2,K+3}), f(14_{4,K+3}), and f(15_{4,K+3}) sending the results to downstream components in the dataflow graph 111. The released results are shaded gray in the DoAll escrow buffer 117 to indicate that they have been released from the escrow buffer. Note that the DoAll component knows, from its recovered state, that results f(5_{2,K+2}), f(6_{2,K+2}), and f(13_{4,K+2}) do not need to be replayed to downstream components in the dataflow graph 111.

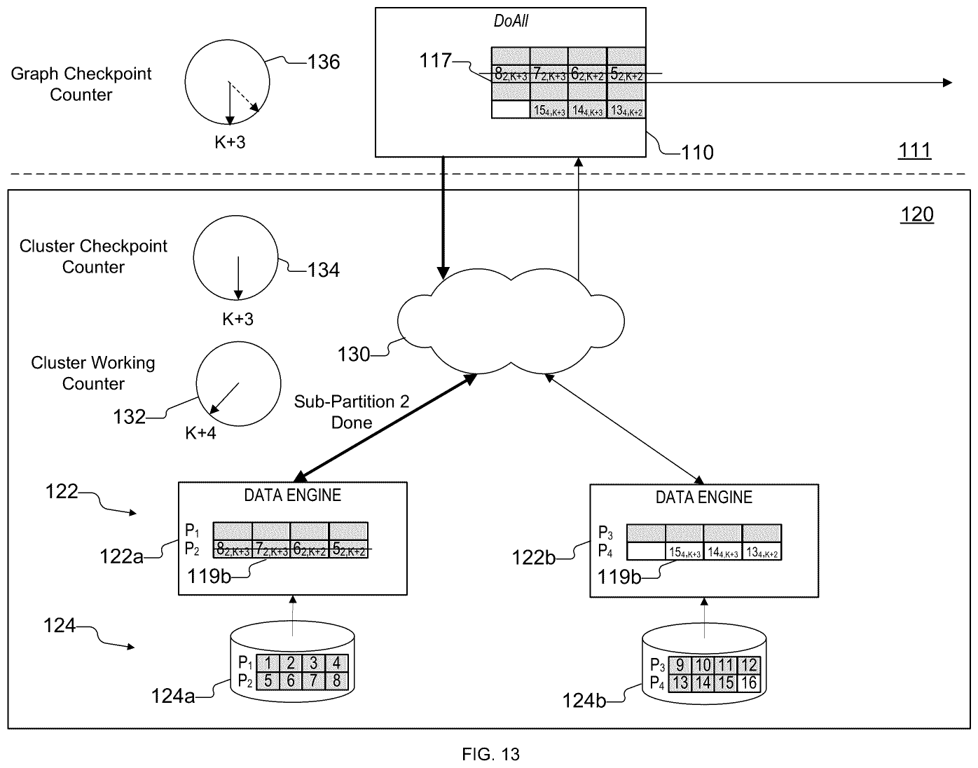

Referring to FIG. 13, when the dataflow graph 111 completes persistently storing state for the graphs checkpoint K+2, the graph checkpoint counter 136 is incremented from K+2 to K+3. The results for sub-partition 2 are removed from the DoAll escrow buffer 117 because they will never need to be replayed from the DoAll escrow buffer 117 (i.e., the data flow graph's state is persistently stored up to graph checkpoint K+3, and all the results for sub-partition 2 have been computed and provided to components downstream from the DoAll component 111).

The DoAll component 111 sends a “Sub-Partition 2 Done” message into the computing cluster 120 to the first data engine 122a. Upon receiving the Sub-Partition 2 Done message, the first data engine 122a removes the results for sub-partition 2 from the first ForAll escrow buffer 116a.

### 5 DATA ENGINE FAILURE AND RECOVERY

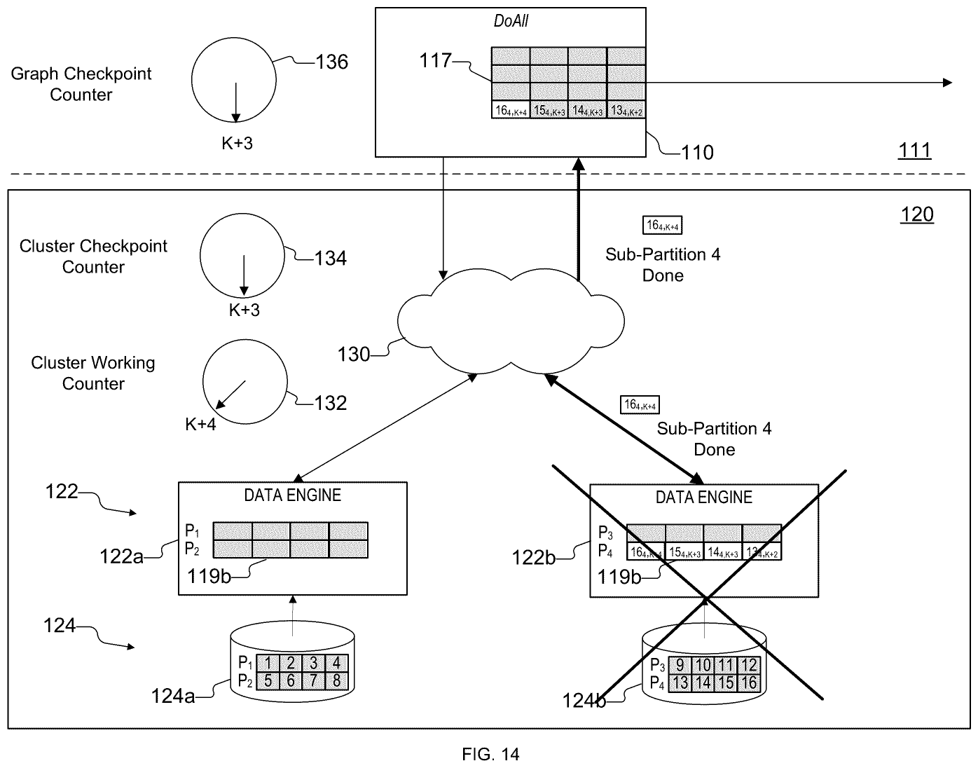

Referring to FIG. 14, the second data engine 122b reads data element 16 from the fourth sub-partition, P₄ of the collection 113. It applies the function, f( ) to the data element to generate processing result “f(16_{4,K+4}).” Result f(16_{4,K+4}) is stored in the ForAll escrow buffer 116b of the second data engine 122b, associated with the fourth sub-partition, P₄. Data element 16 is shaded gray in the second data store 124b to indicate that it has been read and processed by the second data engine 122b. Because all the data elements of the fourth sub-partition, P₄ have been processed, the second data engine 122b issues a “Sub-Partition 4 Done” message.

The processing result f(16_{4,K+4}) is sent out of the computing cluster 120 to the DoAll component 110, where they it is stored in the DoAll escrow buffer 117 in association with sub-partition 4. The Sub-Partition 4 Done message is also sent to the DoAll component 110, where it is stored for later use.

The second data engine 122b then fails. In some examples, failure of the second data engine 122b is detected by the DoAll component 110 and/or the first data engine 122a based on regular messages sent to the second data engine 122b to request a response therefrom, and based on a predetermined threshold time having lapsed without receiving such response. In general, each data engine is replicated at one or more different computing devices (not shown) in the computing cluster 120 to ensure that the computing cluster can resume processing in the event of a data engine failure. In some examples, the replicas are created and maintained by the execution module 112.

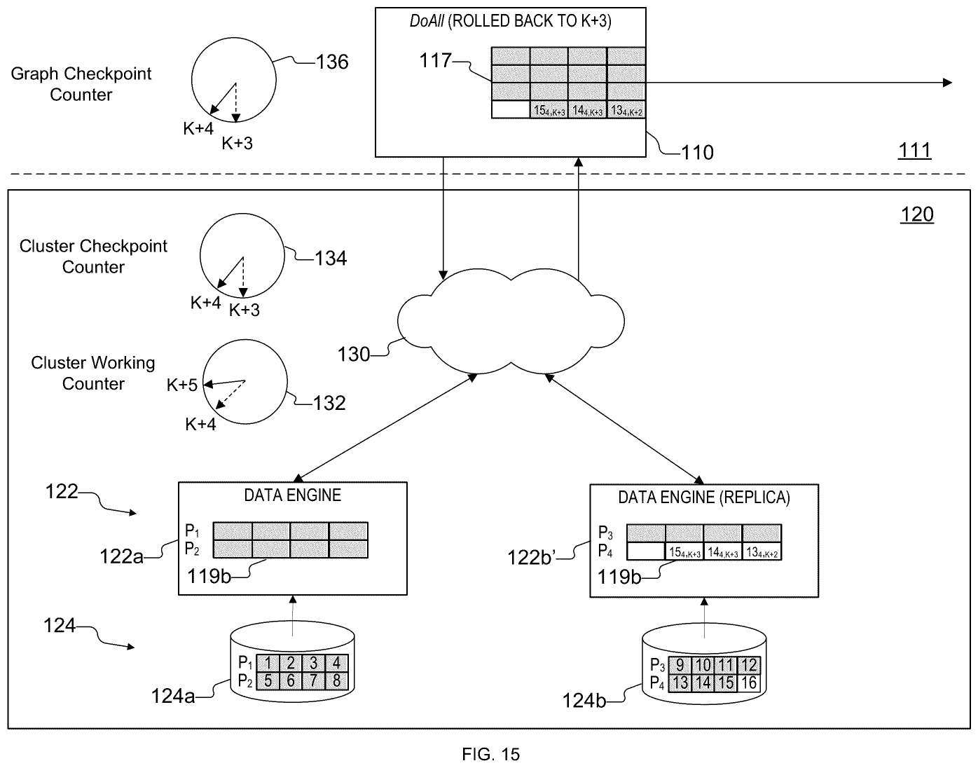

Referring to FIG. 15, a replica of the second data engine 122b′ steps into the place of the failed second data engine 122b. The dataflow graph 111 is rolled back to its state at graph checkpoint K+3. Note that the result of previously processing data element 16 is removed from both the second ForAll escrow buffer 116b and the DoAll escrow buffer 117. The value of the cluster working counter 132 increments from K+4 to K+5, the value of the cluster checkpoint counter increments from K+3 to K+4, and the value of the graph checkpoint counter increments from K+3 to K+4.

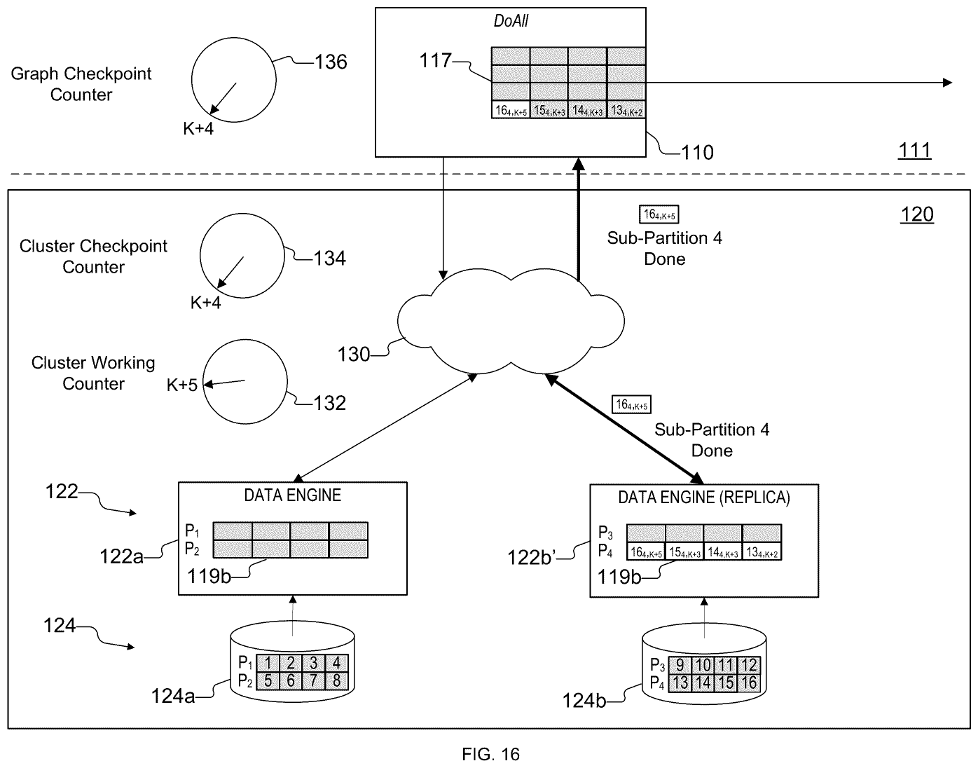

Referring to FIG. 16, the replica of the second data engine 122b′ reads data element 16 from the fourth sub-partition, P₄ of the collection 113 and applies the function, f( ) to the data element to generate processing result “f(16_{4,K+5}).” In some examples, the replica reads the present value of the cluster working counter 132, decrements this value, and reads all data elements associated with the decremented value and assigned to the second data processor. These data elements can be requested from an entity that is responsible for partitioning the data elements and assigning the data elements to the data processors.

Result f(16_{4,K+5}) is stored in the ForAll escrow buffer 116b of the replica of the second data engine 122b′, associated with the fourth sub-partition, P₄. Data element 16 is shaded gray in the second data store 124b to indicate that it has been read and processed by the replica of the second data engine 122b′. Because all the data elements of the fourth sub-partition, P₄ have been processed, the replica of the second data engine 122b′ issues a “Sub-Partition 4 Done” message.

The DoAll component 110 receives the processing results f(5_{2,K+2}), f(6_{2,K+2}), f(7_{2,K+3}), f(8_{2,K+3}), f(13_{4,K+2}), f(14_{4,K+3}), and f(15_{4,K+3}) and stores the results in the DoAll escrow buffer 117 in association with their respective sub-partitions. The Sub-Partition 2 Done message is also received by the DoAll component 110, where it is stored for later use.

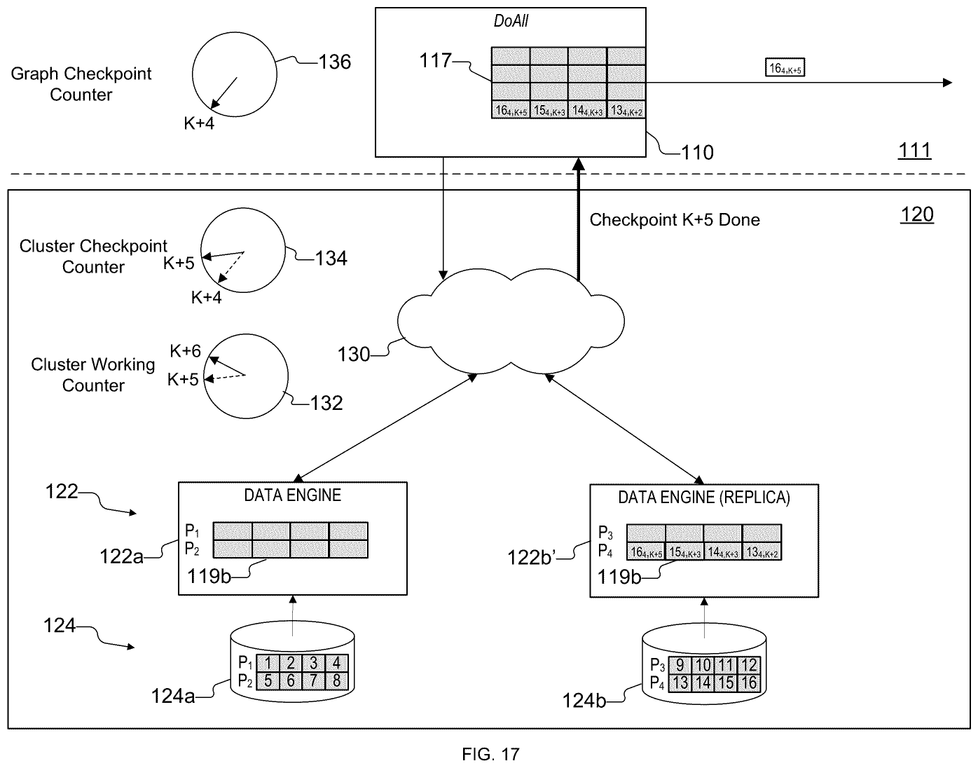

Referring to FIG. 17, when the computing cluster 120 completes persistently storing state for cluster checkpoint K+5, the value of the cluster checkpoint counter 132 is incremented from K+4 to K+5 and the cluster working counter 134 is incremented from K+5 to K+6. A “Checkpoint K+5 Done” message is sent from the computing cluster 120 to the DoAll component 110. Once the DoAll component 110 is informed that checkpoint K+5 is complete in the computing cluster 120, it can safely release all results tagged with checkpoint K+5 from the DoAll escrow buffer 117. In this case, the DoAll component 110 releases result f(16_{4,K+5}), sending the result to downstream components in the dataflow graph 111. The released result is shaded gray in the DoAll escrow buffer 117 to indicate that it has been released from the escrow buffer.

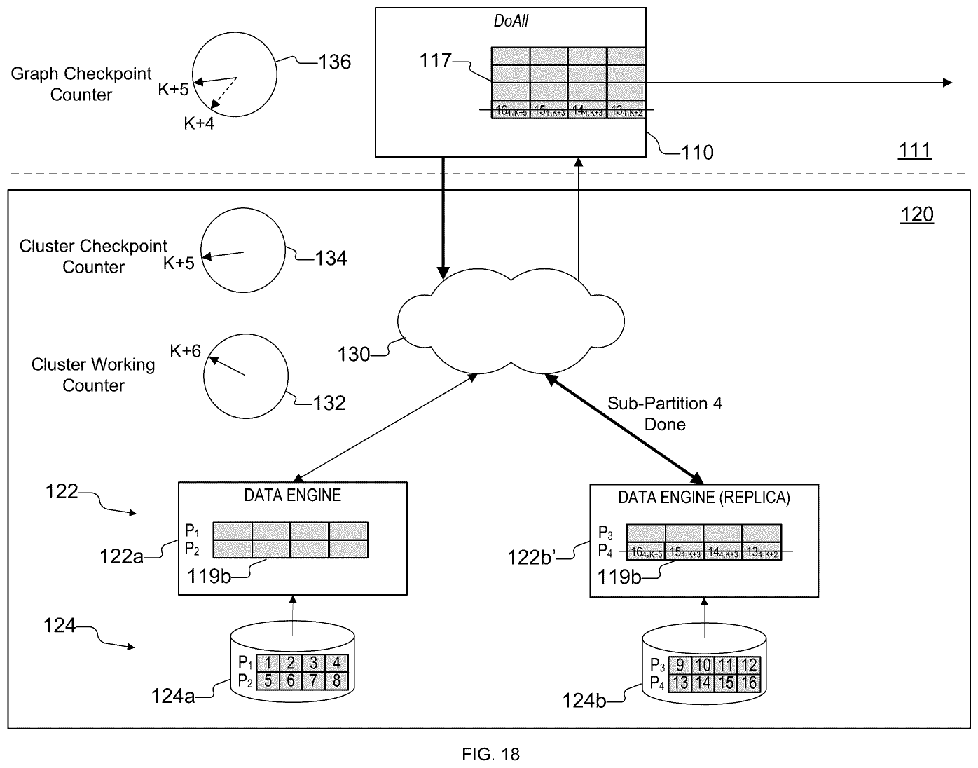

Referring to FIG. 18, when the dataflow graph 111 completes persistently storing state for the graphs checkpoint K+5, the graph checkpoint counter 136 is incremented from K+4 to K+5. The results for sub-partition 4 are removed from the DoAll escrow buffer 117 because they will never need to be replayed from the DoAll escrow buffer 117 (i.e., the data flow graph's state is persistently stored up to graph checkpoint K+5 and all the results for sub-partition 4 have been computed and provided to components downstream from the DoAll component 111).

The DoAll component 111 sends the Sub-Partition 4 Done message into the computing cluster 120 to the second data engine 122b. Upon receiving the Sub-Partition 4 Done message, the second data engine 122b removes the results for sub-partition 4 from the second ForAll escrow buffer 116b.

Referring to FIG. 25, the collection 113 is fully processed.

### 6 IMPLEMENTATIONS

The approaches described above can be implemented, for example, using a programmable computing system executing suitable software instructions or it can be implemented in suitable hardware such as a field-programmable gate array (FPGA) or in some hybrid form. For example, in a programmed approach the software may include procedures in one or more computer programs that execute on one or more programmed or programmable computing system (which may be of various architectures such as distributed, client/server, or grid) each including at least one processor, at least one data storage system (including volatile and/or non-volatile memory and/or storage elements), at least one user interface (for receiving input using at least one input device or port, and for providing output using at least one output device or port). The software may include one or more modules of a larger program, for example, that provides services related to the design, configuration, and execution of dataflow graphs. The modules of the program (e.g., elements of a dataflow graph) can be implemented as data structures or other organized data conforming to a data model stored in a data repository.

The software may be provided on a tangible, non-transitory medium, such as a CD-ROM or other computer-readable medium (e.g., readable by a general or special purpose computing system or device), or delivered (e.g., encoded in a propagated signal) over a communication medium of a network to a tangible, non-transitory medium of a computing system where it is executed. Some or all of the processing may be performed on a special purpose computer, or using special-purpose hardware, such as coprocessors or field-programmable gate arrays (FPGAs) or dedicated, application-specific integrated circuits (ASICs). The processing may be implemented in a distributed manner in which different parts of the computation specified by the software are performed by different computing elements. Each such computer program is preferably stored on or downloaded to a computer-readable storage medium (e.g., solid state memory or media, or magnetic or optical media) of a storage device accessible by a general or special purpose programmable computer, for configuring and operating the computer when the storage device medium is read by the computer to perform the processing described herein. The inventive system may also be considered to be implemented as a tangible, non-transitory medium, configured with a computer program, where the medium so configured causes a computer to operate in a specific and predefined manner to perform one or more of the processing steps described herein.

A number of embodiments of the invention have been described. Nevertheless, it is to be understood that the foregoing description is intended to illustrate and not to limit the scope of the invention, which is defined by the scope of the following claims. Accordingly, other embodiments are also within the scope of the following claims. For example, various modifications may be made without departing from the scope of the invention. Additionally, some of the steps described above may be order independent, and thus can be performed in an order different from that described.

What is claimed is:

1. A method for fault-tolerant processing of a plurality of data elements using a distributed computing cluster, the distributed computing cluster including a plurality of data processors associated with a corresponding plurality of data stores, the method including:
storing the plurality of data elements in the distributed computing cluster, wherein the plurality of data elements is distributed across the plurality of data stores according to a plurality of partitions of data elements;
processing data elements of a first set of partitions of the plurality of partitions stored at a first data store of the plurality of data stores using a first data processor of the plurality of data processors to generate first result data for the data elements of the first set of partitions;
sending the first result data from the distributed computing cluster to a consumer of the first result data outside the distributed computing cluster; and
storing the first result data in a first escrow buffer located in the distributed computing cluster and associated with the first data processor until the consumer has persistently stored the first result data outside the distributed computing cluster.

2. The method of claim 1 further comprising removing the first result data from the first escrow buffer after the consumer has persistently stored all the result data associated with the first partition outside the distributed computing cluster.

3. The method of claim 1 wherein at least some data stores of the plurality of data stores include two or more partitions of data elements of the plurality of data elements.

4. The method of claim 1 wherein the consumer includes a dataflow graph including a consumer component.

5. The method of claim 4 wherein the consumer component of the dataflow graph includes a second escrow buffer for storing result data, the method further comprising storing the first result data in the second escrow buffer.

6. The method of claim 5 wherein the first result data is released from the second escrow buffer based on an indication that the computing cluster has persistently stored a state associated with the first result data.

7. The method of claim 5 further comprising removing the first result data from the second escrow buffer after the consumer has released all result data for the first partition from the second escrow buffer and has persistently stored state information for the dataflow graph.

8. The method of claim 1 further comprising re-sending the first result data from the distributed computing cluster to the consumer based on a determination that the consumer encountered a fault before persistently storing the first result data outside the distributed computing cluster.

9. The method of claim 8 wherein re-sending the first result data includes reading the first result data from the first escrow buffer associated with the first data processor.

10. The method of claim 1 further comprising
determining that the first data processor encountered a fault and, based on that determination
activating a replica of the first data processor based on a determination that the first data processor encountered a fault,
restoring the consumer to its state prior to receiving the first result data from the distributed computing cluster.

11. The method of claim 10 further comprising
processing data elements of the first set of partitions using the replica of the first data processor to generate regenerated result data for the data elements of the first set of partitions;
sending the regenerated result data from the distributed computing cluster to the consumer; and
storing the regenerated result data in the first escrow buffer located in the distributed computing cluster and associated with the replica of the first data processor until the consumer has persistently stored the regenerated result data outside the distributed computing cluster.

12. The method of claim 1 wherein processing the data elements of the first set of partitions includes applying a same function to each data element.

13. The method of claim 1, wherein the processing further comprises:
marking each processing result in the first result data with a partition number and a value of a counter associated with the cluster.

14. The method of claim 1, further comprising:
in response to a predefined number of data elements having finished processing in the distributed computing cluster, incrementing a counter associated with the cluster, and sending a message to the processing component, said message indicating that a checkpoint indicated by the counter has been reached.

15. The method of claim 14, further comprising:
determining that the checkpoint has been reached based on a number of data elements having finished processing by the data processors since a last incrementation of the counter; or
determining that the checkpoint has been reached by determining whether a predetermined time interval has lapsed since a last incrementation of the counter.

16. The method of claim 14, further comprising:
receiving, at the first data processor, a message from the processing component indicating that all data elements associated with a current value of the counter having been removed from the processing component; and
in response to receiving said message, removing the first result data from the first buffer.

17. The method of claim 1, further comprising:
receiving, at the first data processor, a message from the processing component requesting the first data processor to resend the first result data to the processing component; and
sending, by the first data processor, the first result data to the processing component.

18. The method of claim 1, further comprising:
determining, by the first data processor, that the second data processor is subject to failure of operation, in particular wherein the failure of operation is detected based on a message indicating the failure being sent from the second data engine or the second data engine failing to respond to a message regularly sent by the first data processor; and
responsive to determining the failure, replicating the second data processor.

19. The method of claim 18, wherein replicating the second data processor comprises:
identifying, by the first data processor, a further data processor in the plurality of data processors, in particular by identifying a data processor that responds to a message within a threshold time and/or that reports available capacity upon request; and
sending a message to the identified data processor, said message requesting the identified data processor to update its data elements according to a state reflected by a previous value of the first counter, said data elements associated with a partition previously assigned to the second data processor.

20. A system for fault-tolerant processing of a plurality of data elements using a distributed computing cluster, the distributed computing cluster including a plurality of data processors associated with a corresponding plurality of data stores, the system including:
a plurality of data stores, for storing the plurality of data elements, wherein the plurality of data elements is distributed across the plurality of data stores according to a plurality of partitions of data elements;
a plurality of data processors for processing data elements, the plurality of data processors including a first processor for processing a first set of partitions of the plurality of partitions stored at a first data store of the plurality of data stores to generate first result data for the data elements of the first set of partitions;
an output for sending the first result data from the distributed computing cluster to a consumer of the first result data outside the distributed computing cluster; and
a first escrow buffer located in the distributed computing cluster and associated with the first data processor for storing the first result data until the consumer has persistently stored the first result data outside the distributed computing cluster.

21. A computer-readable medium storing software in a non-transitory form, the software including instructions for causing a computing system to process, in a fault tolerant manner, a plurality of data elements using a distributed computing cluster, the distributed computing cluster including a plurality of data processors associated with a corresponding plurality of data stores, the instructions causing the computing system to:
store the plurality of data elements in the distributed computing cluster, wherein the plurality of data elements is distributed across the plurality of data stores according to a plurality of partitions of data elements;
process data elements of a first set of partitions of the plurality of partitions stored at a first data store of the plurality of data stores using a first data processor of the plurality of data processors to generate first result data for the data elements of the first set of partitions;
send the first result data from the distributed computing cluster to a consumer of the first result data outside the distributed computing cluster; and
store the first result data in a first escrow buffer located in the distributed computing cluster and associated with the first data processor until the consumer has persistently stored the first result data outside the distributed computing cluster.

22. A system for fault-tolerant processing of a plurality of data elements using a distributed computing cluster, the distributed computing cluster including a plurality of data processors associated with a corresponding plurality of data stores, the system including:
means for storing the plurality of data elements, wherein the plurality of data elements is distributed across the plurality of data stores according to a plurality of partitions of data elements;
means for processing data elements, the plurality of data processors including a first processor for processing a first set of partitions of the plurality of partitions stored at a first data store of the plurality of data stores to generate first result data for the data elements of the first set of partitions;
means for sending the first result data from the distributed computing cluster to a consumer of the first result data outside the distributed computing cluster; and
storage means, located in the distributed computing cluster and associated with the first data processor for storing the first result data until the consumer has persistently stored the first result data outside the distributed computing cluster.
